(19) United States
(12) Patent Application Publication
(10) Pub. No.: US 2018/0125054 A1
(43) Pub. Date: May 10, 2018

(54) Ultraviolet mosquito-killing lamp with electric shock protection function

(71) Applicant: Yu-Chen Liu, Shenzhen (CN)

(72) Inventor: Yu-Chen Liu, Shenzhen (CN)

(21) Appl. No.: 15/866,484

(22) Filed: Jan. 10, 2018

(30) Foreign Application Priority Data
Oct. 17, 2017 (CN) 201710970647.0

(51) Int. Cl. A01M 1/22; A01M 1/04

(52) U.S. Cl. CPC A01M 1/223; A01M 1/04

(57) ABSTRACT

The invention relates to an ultraviolet mosquito-killing lamp with an electric shock protection function. The ultraviolet mosquito-killing lamp includes a shell, a power line, and an ultraviolet lamp circuit, a high-voltage switching circuit, a high-voltage net and a switch gear which are located in the shell, wherein the ultraviolet lamp circuit is connected with the high-voltage switching circuit, and the high-voltage switching circuit is connected with the high-voltage net; the switch gear is a double-pole switch, and the double-pole switch is electrically connected with the power line. When the ultraviolet mosquito-killing lamp is powered off, both the live wire and the neutral wire are cut off, and thus the electric shock risk caused by the possibility that the live wire is not cut off when a single-pole switch is turned off is avoided.

### BACKGROUND OF THE INVENTION

### Technical Field

The invention relates to an ultraviolet mosquito-killing lamp, in particular, to an ultraviolet mosquito-killing lamp with an electric shock protection function.

### Description of Related Art

Scientific research shows that pests such as insects and mosquitoes have phototaxis, and experimental results show that ultraviolet rays with the wavelength of 365-375 nm can attract most pests of different varieties, such as mosquitoes. Based on this rule, an ultraviolet mosquito-killing lamp attracts mosquitoes through an ultraviolet lamp tube with the wavelength of 365-375 nm, and then winged pests such as mosquitoes are electrically shocked by a high-voltage electric net so as to be killed.

Mosquito-killing lamps on the present market generate high voltage mainly through transformer boosting, high-frequency boosting and capacitor voltage-doubling boosting; however, transformer boosting or high-frequency boosting has the disadvantage of severe interference; capacitor voltage-doubling boosting has the advantage of being free of interference, but has the disadvantage of long-time existence of residual electricity after a power supply is cut off, and consequentially a user can be electrically shocked if mistakenly touching the electric net when cleaning or replacing a lamp tube. The existing mosquito-killing lamp is of a two-pin plug structure and adopts a single-pole switch to serve as a switch gear, namely only one power wire is cut off when the mosquito-killing lamp is turned off, consequentially, it is possible that the neutral wire instead of the live wire is cut off after a power switch is turned off, and under the circumstance, if the customer sees that the power supply is cut off and then opens the protection net to do cleaning, the customer can be electrically shocked.

### BRIEF SUMMARY OF THE INVENTION

To overcome the defect that when a power supply is cut off through a single-pole switch, electric shocks are likely to be caused by the possibility that the live wire is not cut off, the following technical scheme is adopted by the invention: an ultraviolet mosquito-killing lamp with an electric shock protection function comprises a shell, a power line, and an ultraviolet lamp circuit, a high-voltage switching circuit, a high-voltage net and a switch gear which are located in the shell, wherein the ultraviolet lamp circuit is connected with the high-voltage switching circuit, the high-voltage switching circuit is connected with the high-voltage net, the switch gear is a multi-pole switch, and the multi-pole switch is electrically connected with the power line.

According to the ultraviolet mosquito-killing lamp of the invention, the multi-pole switch is a multi-pole multi-throw switch, one terminal of the multi-pole multi-throw switch is connected with the ultraviolet lamp circuit and the high-voltage switching circuit, one terminal of the multi-pole multi-throw switch is connected with an external power supply, and another terminal of the multi-pole multi-throw switch is connected with the output terminal of the high-voltage net to form a high-voltage discharge circuit.

According to the ultraviolet mosquito-killing lamp of the invention, the multi-pole switch is a multi-pole single-throw/multi-throw switch, the multi-pole single-throw/multi-throw switch is connected with a relay, the relay is connected with a discharge circuit, a normally-closed contact of the relay is connected with the output terminal of the high-voltage net, and the common terminal of the relay is connected the other terminal of the high-voltage net.

According to the ultraviolet mosquito-killing lamp of the invention, the multi-pole switch is a multi-pole single-throw/multi-throw switch, the multi-pole single-throw/multi-throw switch is connected with a delay promotion controller, the delay promotion controller is connected with a semiconductor high-voltage discharge circuit, and the semiconductor high-voltage discharge circuit is connected to the discharge terminal of the high-voltage net.

According to the ultraviolet mosquito-killing lamp of the invention, the shell is connected with a ground wire, and the power line is of a three-pin plug structure.

The ultraviolet mosquito-killing lamp with an electric shock protection function of the invention has the following beneficial effects that the multi-pole switch is used for replacing a single-pole switch in the prior art, both the live wire and the neutral wire are cut off while the power supply is cut off, and thus the operation safety is improved; the multi-pole multi-throw/single-throw switch is connected with the relay discharge circuit or the semiconductor high-voltage discharge circuit or is directly connected with a discharge circuit, so that residual electricity of the high-voltage net is released, and the user is protected against electric shocks caused by residual electricity; the shell is grounded, the power line is of the three-pin plug structure, and thus electric leakage of the shell caused by contact between the metal shell and the live wire is avoided. According to the ultraviolet mosquito-killing lamp of the invention, various design schemes are adopted for improving existing mosquito-killing lamps, so that the electric shock protection performance of the ultraviolet mosquito-killing lamp is improved comprehensively, and the user can use the ultraviolet mosquito-killing lamp safely.

### BRIEF DESCRIPTION OF THE SEVERAL VIEWS OF THE DRAWINGS

A further description of the invention is given with the accompanying drawings and embodiments as follows, in the drawings:

FIG. 1 is circuit block diagram of an ultraviolet mosquito-killing lamp with an electric shock protection function in a first embodiment of the invention;

FIG. 2 is a circuit block diagram of an ultraviolet mosquito-killing lamp with an electric shock protection function in a second embodiment of the invention;

FIG. 3 is a circuit block diagram of an ultraviolet mosquito-killing lamp with an electric shock protection function in a third embodiment of the invention; and

FIG. 4 is a circuit block diagram of an ultraviolet mosquito-killing lamp with an electric shock protection function in a fourth embodiment of the invention.

### DETAILED DESCRIPTION OF THE INVENTION

For a better understanding of the purposes, technical schemes and advantages of the invention, a further detailed description of the invention is given with the accompanying drawings and the embodiments as follows. It should be understood that the specific embodiments in the following description are only used for explaining the invention instead of being used for limiting the invention.

### First Embodiment

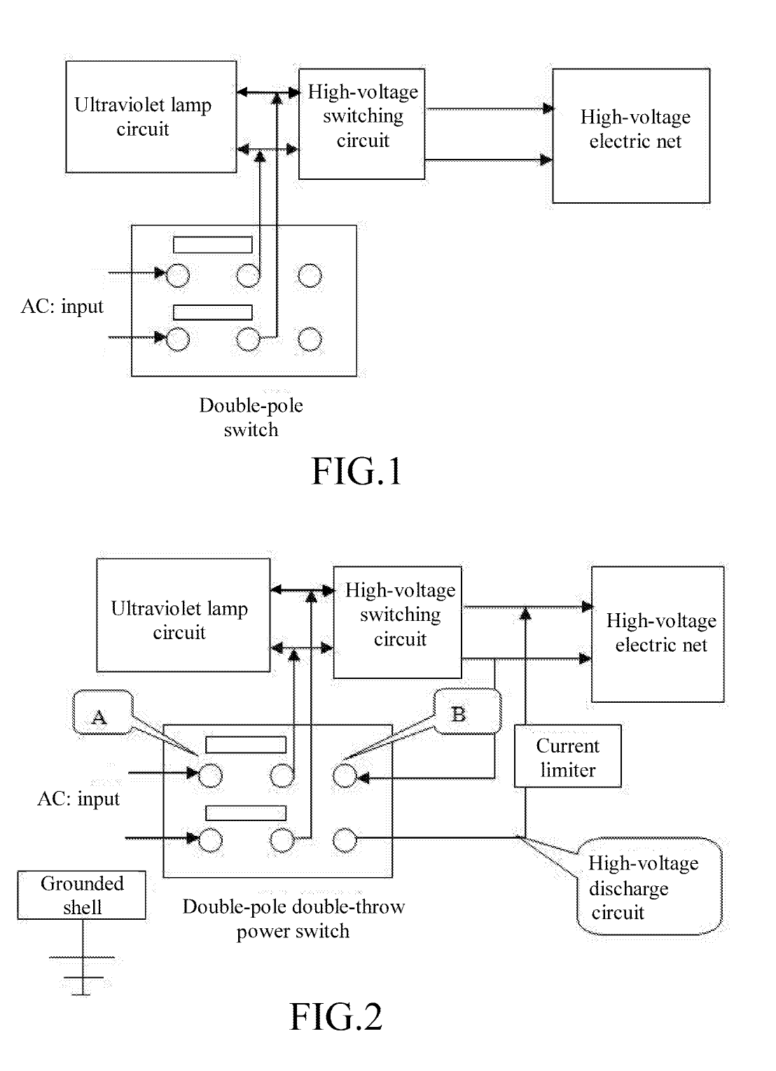

As is shown in FIG. 1, an ultraviolet mosquito-killing lamp with an electric shock protection function comprises a shell, a power line, and an ultraviolet lamp circuit, a high-voltage switching circuit, a high-voltage net and a switch gear which are located in the shell, wherein the ultraviolet lamp circuit is connected with the high-voltage switching circuit, and the high-voltage switching circuit is connected with the high-voltage net; the switch gear is a double-pole switch, the power line is connected with an external power supply and supplies power to the mosquito-killing lamp, and the double-pole switch is connected with the live wire and the neutral wire of the power line. In this way, when the switch is turned on, the ultraviolet mosquito-killing lamp is powered on by the external power supply and lights up to attract mosquitoes, and the high-voltage net generates high voltage at the moment, so that pests such as mosquitoes and flies entering the electric net are killed by electric shocks; when the switch is turned off, both power wires, namely the live wire and the neutral wire, are cut off, and thus users are protected against electric shocks caused when touching the live wire while clearing away electrocuted mosquitoes and flies.

### Second Embodiment

Furthermore, based on the first embodiment, as is shown in FIG. 2, the double-pole switch is a double-pole double-throw switch, the terminal A of the double-pole double-throw switch is connected with the live wire and the neutral wire of the power line, the terminal B of the double-pole double-throw switch is connected with the output terminal of the high-voltage net, and the middle common terminal of the double-pole double-throw switch is connected with a load. When the terminal A of the switch is powered on, the ultraviolet lamp circuit operates to turn on the ultraviolet lamp, and the high-voltage circuit supplies power to the high-voltage electric net; when the terminal B of the switch is powered off, the double-pole switch is connected with a high-voltage output discharge terminal, the middle common terminal is connected with the ultraviolet lamp circuit and the high-voltage circuit, and residual electricity of the high-voltage electric net is released by means of the load. In this way, when the switch is turned off, the two power wires are cut off, and thus users are protected against electric shocks caused when the live wire is not cut off; then residual electricity of the high-voltage electric net is released, and thus the users are also protected against electric shocks caused by residual electricity of the high-voltage net. The users can clear away electrocuted mosquitoes and flies safely without the worry of electric shocks.

### Third Embodiment

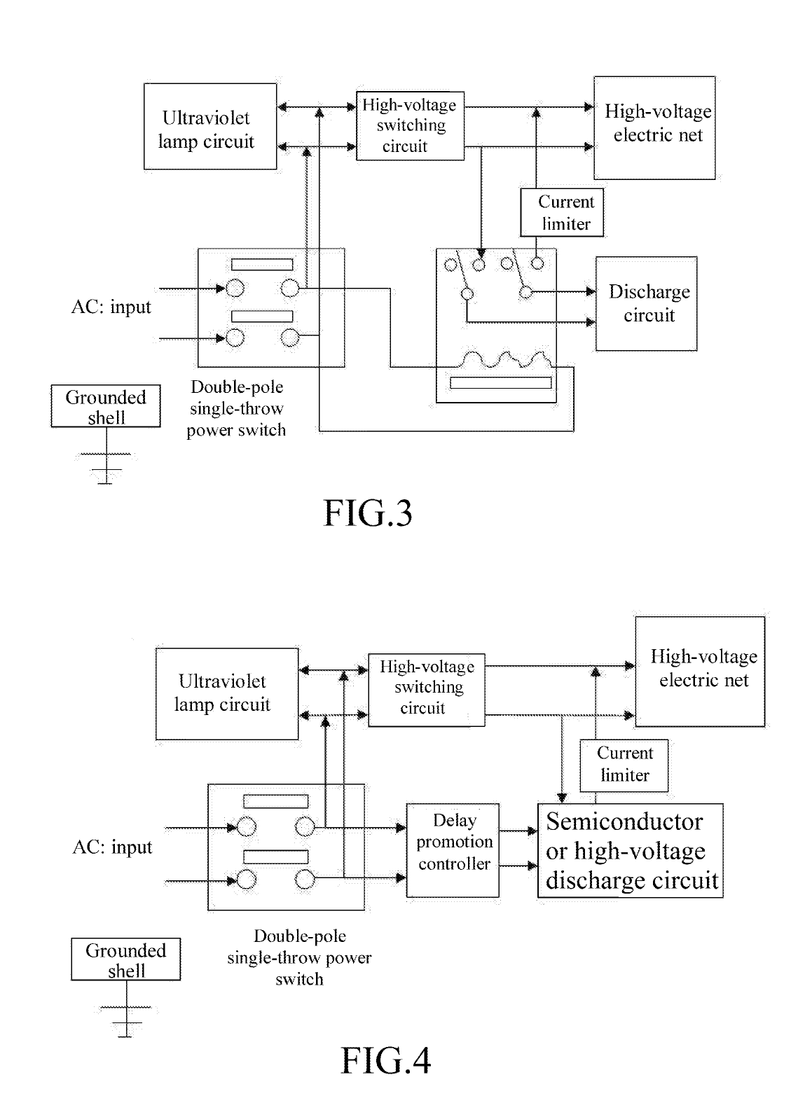

Based on the first embodiment, as is shown in FIG. 3, the double-pole switch is a double-pole single-throw switch, the double-pole single-throw switch is connected with a relay, the relay is connected with a discharge circuit, and a normally-closed contact of the relay is connected with the output terminal of the high-voltage net, and the middle common terminal of the relay is connected the other terminal of the high-voltage net.

When the double-pole single-throw switch is turned on, the ultraviolet mosquito-killing lamp is powered on, the relay is also powered on at the moment, so that the normally-closed terminal of the relay is attracted to be opened and is disconnected with the high-voltage net, an ultraviolet lamp tube lights up, the high-voltage switching circuit supplies power to the high-voltage net at the moment, and the whole ultraviolet mosquito-killing lamp starts to operate; when the power switch is turned off, the live wire and the neutral wire are cut off, the relay is powered off, the normally-closed contact is closed and connected with the output terminal of the high-voltage net, the discharge circuit is closed to release residual electricity of the high-voltage net, and thus users are protected against electric shocks caused by residual electricity of the high-voltage net when cleaning the electric net. In this way, the users can safely clear away electrocuted mosquitoes and flies or safely replace the lamp tube by turning off the power switch or by pulling out the plug.

### Fourth Embodiment

Based on the first embodiment, as is shown in FIG. 4, the double-pole switch is a double-pole single-throw switch, the double-pole single-throw switch is connected with a delay promotion controller, the relay promotion controller is connected with a semiconductor high-voltage discharge circuit, a semiconductor element is a discharge element in the high-voltage discharge circuit, and the control terminal of the element is connected to the discharge terminal of the high-voltage net.

When the double-pole single-throw power switch is turned on, the ultraviolet lamp circuit is closed, an ultraviolet lamp tube lights up, the high-voltage switching circuit is also closed to supply power to the high-voltage electric net, and the delay promotion controller is powered on at the moment; when the power switch is turned off, the semiconductor high-voltage discharge circuit operates for a short time under the delaying effect of the delay promotion controller, namely the semiconductor element which discharges through a capacitor at the control terminal of the semiconductor element operates for a short time to release residual electricity of the high-voltage net; as the power switch is a double-pole switch, both power wires are cut off when the double-pole switch is turned off, and accordingly users are protected against electric shocks caused by residual electricity of the high-voltage electric net and electric shocks caused by the non-cut-off live wire when cleaning the mosquito-killing lamp.

### Fifth Embodiment

Based on the above embodiments, as is shown in FIGS. 2-4, the shell of the mosquito-killing lamp is connected with a ground wire, and the power line is of a three-pin plug structure. When the shell of the mosquito-killing lamp is a metal shell, the metal shell is quite likely to make contact with the live wire, and consequentially, electric shock risks of the whole mosquito-killing lamp are caused; as the shell is connected to the ground wire and the power line is of the three-pin plug structure, if the shell makes contact with the live wire, a circuit is formed by the live wire and the ground wire, and thus users are protected against potential safety hazards caused by electric leakage of the shell.

According to the ultraviolet mosquito-killing lamp of the invention, both the live wire and the neutral wire are cut off while the switch is turned off, and thus electric shock risks caused when the live wire is not cut off are avoided; the double-pole double-throw switch and the double-pole single-throw switch are externally connected with the relay discharge circuit or the semiconductor high-voltage discharge circuit, so that residual electricity of the high-voltage net is released after the switch is turned off, and the operation safety is further improved; the shell is grounded, so that potential safety hazards caused by contact between the shell and a live wire funnel are avoided. Various electric shock protection methods and measures are provided by the invention, and compared with existing products, safety is remarkably improved. By adoption of the improved safety design scheme of the invention, users can be better protected and safer, the users can be protected against electric shocks by turning off the power switch or by pulling out the plug even if electric leakage happens to the metal shell, and thus the users can use the ultraviolet mosquito-killing lamp more safely.

The ultraviolet mosquito-killing lamp of the invention is suitable for places such as indoor families, hotels, farms, supermarkets, warehouses and balconies and is used for killing pests such as mosquitoes and flies. The effective mosquito attraction range of the ultraviolet mosquito-killing lamp of the invention can be as wide as 100 square meters.

What needs to be pointed out is that to achieve the same effects, the double-pole switch in the embodiments can be replaced by a multi-pole switch, the double-pole double-throw switch can be replaced by a multi-pole multi-throw switch, and the double-pole single-throw switch can be replaced by a multi-pole multi-throw/single-throw switch; in addition, the measures for releasing residual electricity in the high-voltage net in the second, third and fourth embodiments are taken for mosquito-killing lamps adopting capacitor voltage-doubling for boosting.

Although the invention is disclosed through the above embodiments, the protection scope of the invention is not limited to the above embodiments, and transformations, substitutes and the like of the above components made without deviating from the concept of the invention are all within the claim scope of the invention.

What is claimed is:

1. An ultraviolet mosquito-killing lamp with an electric shock protection function, characterized by comprising a shell, a power line, and an ultraviolet lamp circuit, a high-voltage switching circuit, a high-voltage net and a switch gear which are located in the shell, wherein the ultraviolet lamp circuit is connected with the high-voltage switching circuit, the high-voltage switching circuit is connected with the high-voltage net, the switch gear is a multi-pole switch, and the multi-pole switch is electrically connected with the power line.

2. The ultraviolet mosquito-killing lamp according to claim 1, characterized in that the multi-pole switch is a multi-pole multi-throw switch, one terminal of the multi-pole multi-throw switch is connected with the ultraviolet lamp circuit and the high-voltage switching circuit, one terminal of the multi-pole multi-throw switch is connected with an external power supply, and another terminal of the multi-pole multi-throw switch is connected with the output terminal of the high-voltage net to form a high-voltage discharge circuit.

3. The ultraviolet mosquito-killing lamp according to claim 1, characterized in that the multi-pole switch is a multi-pole single-throw/multi-throw switch, the multi-pole single-throw/multi-throw switch is connected with a relay, the relay is connected with a discharge circuit, a normally-closed contact of the relay is connected with the output terminal of the high-voltage net, and the common terminal of the relay is connected with the other terminal of the high-voltage net.

4. The ultraviolet mosquito-killing lamp according to claim 1, characterized in that the multi-pole switch is a multi-pole single-throw/multi-throw switch, the multi-pole single-throw/multi-throw switch is connected with a delay promotion controller, the delay promotion controller is connected with a semiconductor high-voltage discharge circuit, and the semiconductor high-voltage discharge circuit is connected to the discharge terminal of the high-voltage net.

5. The ultraviolet mosquito-killing lamp according to claim 1, characterized in that the shell is connected with a ground wire, and the power line is of a three-pin plug structure.

6. The ultraviolet mosquito-killing lamp according to claim 2, characterized in that the shell is connected with a ground wire, and the power line is of a three-pin plug structure.

7. The ultraviolet mosquito-killing lamp according to claim 3, characterized in that the shell is connected with a ground wire, and the power line is of a three-pin plug structure.

8. The ultraviolet mosquito-killing lamp according to claim 4, characterized in that the shell is connected with a ground wire, and the power line is of a three-pin plug structure.
